(19) United States
(12) Patent Application Publication
(10) Pub. No.: US 2020/0247110 A1
(43) Pub. Date: Aug. 6, 2020

(54) MOTION CORRECTION IN ADDITIVE MANUFACTURING

(71) Applicant: HEWLETT-PACKARD DEVELOPMENT COMPANY, L.P., Spring, TX (US)

(72) Inventors: Tod Heiles, Sumner, WA (US); Sunil Kothari, Palo Alto, CA (US); Juan Carlos Catana, Guadalajara (MX); Brent Ewald, Vancouver, WA (US); Jun Zeng, Palo Alto, CA (US); Gary J. Dispoto, Palo Alto, CA (US)

(73) Assignee: HEWLETT-PACKARD DEVELOPMENT COMPANY, L.P., Spring, TX (US)

(21) Appl. No.: 16/753,267

(22) PCT Filed: Jan. 18, 2018
(86) PCT No.: PCT/US2018/014199

§ 371 Date: Apr. 2, 2020

(51) Int. Cl. B33Y 10/00; B33Y 30/00

(52) U.S. Cl. CPC B33Y 10/00; B33Y 50/02; B33Y 30/00

(57) ABSTRACT

A system for forming an object, the system including: a carriage, wherein the carriage moves above an area for forming the object and laterally with respect to the area, the carriage comprising an electromagnetic radiation source to induce heating of material in the area; a thermal imaging device to image the area, wherein the thermal imaging device captures a plurality of sequential images; and a processor, wherein the processor uses the plurality of sequential images to create a temperature map of the area which includes compensation for the cooling which occurs during the movement of the carriage lateral to the area.

### BACKGROUND

Additive manufacturing (AM) describes a family of processes which involve the piecewise addition of material to a developing part. This contrasts with subtractive manufacturing, which describes machining processes which removes material to form a desired object, e.g., lathe. In some types of additive manufacturing, a piece is formed layer by layer until finished. One such technique selectively melts layers of particulate to form three dimensional objects. The customization and just-in-time qualities of additive manufacturing techniques, along with the relatively high degree of automation and low operator time per part are some reasons why additive manufacturing may replace other manufacturing methods.

### BRIEF DESCRIPTION OF THE DRAWINGS

The accompanying drawings illustrate various examples of the principles described herein and are a part of the specification.

FIG. 1 shows an example of a system for forming an object according to an example consistent with this specification.

FIG. 2 shows an example of a system for forming an object according to an example consistent with this specification.

FIG. 3 shows flowchart for a method of forming an object consistent with this specification.

FIG. 4 shows a series of images of an area for forming an object and a composite image formed from the series of images in an example consistent with this specification.

In the drawings and specification, reference numbers designate similar, but not necessarily identical, elements. The figures are not necessarily to scale, and the size of some parts may be exaggerated to more clearly illustrate the example shown. Moreover, while the drawings provide examples and/or implementations consistent with the description; the description includes all material disclosed in the specification and not just the examples shown in the drawings.

### DETAILED DESCRIPTION

Additive manufacture using layer by layer assembly provides a number of benefits. Complex geometries can be formed. Layer formation and consolidation may be faster than applying all the material through a dispenser. The unfused portions of the layers may serve to support and/or insulate the developing parts. The unfused particles may be reused and/or recycled. Layers of uniform thickness may aid in process control and/or repeatability. A whole layer may be masked and/or otherwise treated simultaneously rather than bit by bit. This may increase throughput.

The use of heat is one technique used to solidify pieces. Portions of the layer to be converted into pieces may be selectively heated above the melting point of the particles. In other examples, the portions forming the pieces are heated above a sintering temperature allowing the particles to fuse together without true melting. Lower temperatures may also be used to provide adhesion between particles. Control of the time-temperature profile during this process has an impact on the mechanical properties of the resulting pieces. Tighter control over the temperature profile allows better optimization of the desired profile while avoiding falling outside the process window and into an undesirable regime. Both too high of temperatures and too low of temperatures may produce suboptimal parts.

Increasing the size of the forming beds used to produce pieces and, in turn, the size of pieces that can be produced is an area of ongoing interest in additive manufacture. Such scale up promises to reduce the per piece production cost. However, larger forming beds introduce additional challenges. Larger beds may take longer to form and process a layer. Larger beds may have uniformity issues introduced by differences processing time from one side of the bed to the other. Larger beds may have different cooling behavior although larger beds also have less edge/surface area to area/volume which may produce different cooling dynamics. Larger beds may have longer traverse times for spreaders; lamps; cameras, and other components. These issues can all complicate process control of larger forming beds.

One system design for layer by layer additive manufacture uses a spreader to provide a layer of particles; a heating lamp; a fusing lamp; and/or an ejector device. These components may be mounted on carriages to allow them to traverse the bed. In an example, a carriage may allow two axis motion (e.g., X and Y) while maintaining a height (Z) above the current particle layer. Carriages may include a full width active element and limit the motion to a single axis (e.g., X). As the full width element passes from one side of the bed to the other, the entire working area of the bed may be treated and/or exposed depending on the particular working element. For example, an ejector device may mask portions of the particle layer and/or apply absorbing materials to portions of the particle layer where pieces are being formed. An electromagnetic radiation source may provide broad spectrum and/or narrow spectrum radiation to induce chemical and/or thermal reactions. In an example, the electromagnetic radiation source is a heat lamp.

A full width heat lamp may move in a single axis with the carriage. The full width heat lap may also reduce the total time to apply a desired amount of heat. However, many practical lamp designs have non-uniformity along the axis of the lamp, making application of a uniform exposure more complex, even when the lamp/layer separation is maintained constant. This can introduce non-uniformity into the heating process, for example, at the ends of the lamp and/or between multiple bulbs and/or filaments. Further, lamp behavior may change over time as the lamp ages and/or accumulates contaminants on its covers/bulbs etc. The lamp can also exhibit non-uniformity in the direction of travel. The startup and shutdown profiles for the lamp include ramp times. Preheating the electromagnetic radiation source to steady state is not always practical prior to beginning a pass from one side of the bed to the other. Preheating may introduce additional delays, which in turn, may allow more heat to migrate from the work bed. Waiting delays may worsen temperature gradients in the particle layer. Accordingly, tradeoffs exist when trying to minimize the non-uniformities and process time, where longer process times do not always produce better more uniform results.

As used in this specification and the associated claims, X refers to a length of an area for forming the object. Y refers to a width of the area for forming the object Z refers to a height over the area for forming the object. The carriage moving the electromagnetic radiation source moves in X and may also move in Y and/or Z. A layer of material in the area extends in X and Y. Successive layers are offset from each other in Z. The directions of X, Y, and Z are each orthogonal to the plane formed by the other two directions.

As used in this specification and the associated claims, a temperature map is a corrected thermal image where some values have been adjusted to correct for differences in time between exposure to an electromagnetic radiation source and acquisition of the image.

As used in the specification and the associated claims, a mask is a compensation function and/or matrix which may be applied to an unmodified image to obtain a corrected thermal image and/or temperature map.

Among other examples, a system for forming an object, the system including: a carriage, wherein the carriage moves above an area for forming the object and laterally with respect to the area, the carriage including an electromagnetic radiation source to induce heating of material in the area; a thermal imaging device to image the area, wherein the thermal imaging device captures a plurality of sequential images; and a processor, wherein the processor uses the plurality of sequential images to create a temperature map of the area which includes compensation for the cooling which occurs during the movement of the carriage lateral to the area.

Among other examples, this specification also describes a system for forming an object, the system including: a carriage, the carriage controllable to move back and forth above an area for forming the object; a thermal imagining device, controllable to move back and forth above the area for forming the object; an electromagnetic radiation source to induce heating of material in the area for forming the object, the electromagnetic radiation source moving with the carriage; a memory, the memory comprising a mask associated with a first carriage speed; and a processor, the processor to apply the mask to an image of the area for forming the object captured by the thermal imaging device.

A method of forming an object, the method including: selectively heating a layer of particulate material to consolidate an area of the particulate material, using an electromagnetic radiation source located above the layer of particulate material, wherein the electromagnetic radiation source moves laterally with respect to the layer of particulate; imaging multiple sequential images of the layer of particulate material using a thermal imaging device; and forming a composite image from the multiple sequential images wherein the composite images reduces the cooling artifact introduced by motion of the electromagnetic radiation source relative to the layer of particulate material, such that different portions of the composite image are based on different images of the sequential images to reduce variation between time from exposure the electromagnetic radiation source to image capture across the composite image.

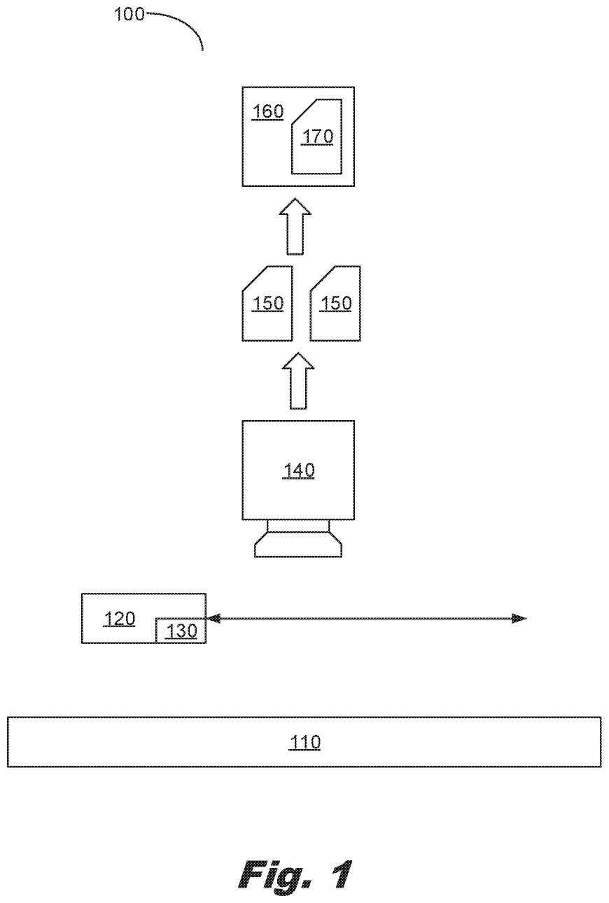

Turning now to the figures, FIG. 1 shows an example of a system (100) for forming an object, the system including: a carriage (120), wherein the carriage (120) moves above an area (110) for forming the object and laterally with respect to the area (110), the carriage (120) including an electromagnetic radiation source (130) to induce heating of material in the area (110); a thermal imaging device (140) to image the area (110), wherein the thermal imaging device (140) captures a plurality of sequential images (150); and a processor (160), wherein the processor (160) uses the plurality of sequential images (150) to create a temperature map of the area (110) which includes compensation for the cooling which occurs during the movement of the carriage (120) lateral to the area (110).

The system (100) is a system for forming objects. The system may include other components in addition to those described above. The system (100) may include a spreader and/or roller to facilitate forming layers. The system (100) may include a dispenser do deposit particles and/or material use to form the layers. The system (100) may include a liquid ejector, such as a printhead. A liquid ejector may deposit material, such as a printing liquid and/or agent, to reduce the absorption of electromagnetic radiation from the electromagnetic radiation source (130). A liquid ejector may deposit material, such as a printing liquid or agent, to increase absorption of electromagnetic radiation from the electromagnetic radiation source (130). The liquid ejector may deposit material that chemically reacts with the material of the layer when exposed to electromagnetic radiation from the electromagnetic radiation source (130).

The system (100) may include additional sensors to detect and/or monitor operating conditions. In an example, this includes a thermal sensor integrated into the area (110) for forming the object to monitor temperature in a location not visible to the thermal imaging device (140), for example, in the surface of the area (110) covered with a layer of the object being formed.

The area (110) for forming the object provides a location to support the accumulating layers of material being used to form the objects. The area (110) may be a forming bed. The area (110) may include a heater. The area (110) may include a sensor. The top surface of the area (130) may be flat.

The carriage (120) moves the electromagnetic radiation source (130) so that the area (110) being used to build the object(s) is exposed to an appropriate amount of electromagnetic radiation from the electromagnetic radiation source (130). The carriage (120) moves in a first axis relative to the area (110). The carriage (120) may move in multiple axes. In an example, the carriage moves in both X and Y while maintaining a constant separation from the layer in the area (110). The carriage may move in Z to modify the footprint and intensity of the electromagnetic radiation reaching the area (110).

The carriage (120) may be controlled to move at a constant speed. The carriage (120) may be controlled to move at variable speed to increase and/or decrease the amount of electromagnetic radiation exposure of different portions of the area (110). In an example, the carriage (120) includes a moveable shutter which may be dynamically adjusted to control the exposure from the electromagnetic radiation source (130).

The electromagnetic radiation source (130) provides electromagnetic radiation to heat material in the area (110). The electromagnetic radiation source (130) may be a heat source, such as a heat lamp. The electromagnetic radiation source (130) may include a visible component. The electromagnetic radiation source (130) may be a broad spectrum emitter and/or a narrow spectrum emitter. The electromagnetic radiation source may include ultraviolet (UV) radiation. The UV radiation may be absorbed and re-radiated as heat and/or lower energy radiation. The UV radiation may initiate a chemical reaction in the build object. In an example, UV radiation may be used to crosslink the build object.

The system (100) includes a thermal imaging device (140). The thermal imaging device (140) is positioned and/or positionable so as to acquire images of areas of the forming bed being used to form objects. The thermal imaging device may be a thermographic camera, i.e. an infrared (IR) camera. The thermal imaging device may output information as discrete images and/or continuous signals. If the output is in continuous signals, images may be formed by measuring the signals over time, e.g. taking an average value. Image forming may compensate for the motion of the carriage.

The output from the thermal imaging device (140) may be images (150) and/or may be used to form images (150). An image (150) is a positional map of a variable strongly associated with the surface temperature of a position of the area (110). The variable may be counts, frequency, intensity, and/or a combination of variables. In an example, the output is converted to an array containing temperature at X and Y coordinates. In another example, the output is processed as an output variable and converted to temperature after all the processing is completed.

The image (150) may represent all of the area (110). The image (150) may represent a portion of the area (110), The image (150) may have areas excluded and/or corrected. For example, the image (150) may include an area where a portion of the area (110) is obstructed by the carriage (120). This portion of the image may be excluded from use in subsequent calculations because this portion represented the carriage temperature, not the temperature of the material layer. In an example, a flag and/or value (e.g., zero) may be substituted into points in the image to be excluded from subsequent calculations. This may avoid having to detect this data in subsequent processing and allow detection of the flag to determine inclusion/exclusion. In an example, the region of excluded data points is given a margin to avoid potentially compromised. The margin may be corrected based on other local information in the image.

The processor (160) processes the images and forms a temperature map (170). The temperature map (170) compensates for any artifacts introduced by motion of the carriage (120) and the electromagnetic radiation source (130). The processor (160) may be local to the other parts of the system (100). The processor (160) may be remote to the other parts of the system (100). In an example, the thermal imaging device transmits the images (150) to the processor (160). For example, the images (150) may be transmitted via wired and/or wireless networks.

The temperature map (170) shows the compensation for motion of the electromagnetic radiation source (120) relative to the area (110). As the electromagnetic radiation source (120) passes across the area (110) different portions of the area (110) are heated. Accordingly, for an image (150) capturing a formed layer in the area (110), the part nearest the end of travel of the carriage (120) will be warmer than the end where the carriage (120) started.

The information about the motion of the carriage (120) and multiple images from the thermal imaging device (140) may be used to allow reduction of the motion artifact. An image (150) with the motion artifact minimized is referred to herein as a temperature map (170). Later on, this specification will discuss the use of a mask (290) to convert an image (150) into a temperature map (170).

The temperature map (170) may be a mean temperature map. The temperature map (170) may be a peak temperature map. The temperature map (170) may show the temperature of each position of a layer on the forming bed at a constant time after exposure to the electromagnetic radiation source (130), The temperature map (170) may include temperature points taken directly from images (150) produced by the thermal imaging device (140). In such an approach, each temperature point is a direct measurement from a single image and the temperature map (170) includes temperature points from multiple images. The temperature map (170) may include temperature points linearly-interpolated between two sequential images (150). The temperature map (170) may include temperature points calculated using a non-linear model. Such a non-linear model may use three and/or more time points to calculate a temperature value for a point in the temperature map (170).

The temperature map (170) may calculate each pixel of the map using the same technique with independent calculations for each pixel. The temperature map may perform the calculation for columns of pixels as a group, where the electromagnetic radiation source (130) extends in the direction of the column (e.g. Y) and moves lateral to the column (e.g. X). The temperature map (170) may calculate offset for a location and then apply this offset to other locations of the map, for example, areas within the same column which have a similar temperature. The offset may be applied based on similarity of adjacent areas, for example, the system could calculate an offset for consolidating regions and a second offset for non-consolidating regions. These two offsets could then be applied to the column based on whether the pixel was a consolidating region or a non-consolidating region.

The determination of consolidating region vs. non-consolidating region could be taken from a build plan and/or from the temperature measurements of an image (150). In an example, a pixel is considered consolidating if the calculated peak temperature is above a melting point for the particulate forming the particulate layer. In another example, a pixel is considered consolidating if the calculate peak temperature is at least a fixed number of degrees above a melting temperature for the particulate forming the particulate layer, A pixel may be considered consolidating based on its temperature relative to a sintering temperature instead of and/or as an adjunct to the use of melting temperature.

The processor (160) may use a second group of images (150) with the first group of images (150) when forming the temperature map (170). The two groups of images (150) may represent different passes of the carriage (120) across the area (110). The two groups of images (150) may represent different layers in the area (110). The two groups of images (150) may be images captured while the carriage (120) obstructs view of a portion of the top layer in the area (110) and images (150) captured where the entire top layer in the area (110) is visible within the image (150), e.g., after the carriage (120) has exited the field of view of the thermal imaging device (140). Other combinations of the above groups and/or other images acquired by the thermal imaging device (140) may be used to create the temperature map (170).

The temperature map (170) may be used to create a mask (280) and store the mask in an associated memory (290). A mask is a set of offsets from an image which may be applied to an image (150) to correct for the motion artifact from the carriage (120) moving the electromagnetic radiation source (130). In an example, a mask (280) is created by calculating, on a pixel by pixel basis and/or column by column basis, the difference between an unobstructed image of the forming bed and the temperature map (170). The mask (280) may be adjusted to set a reference pixel value to zero by subtracting the value of the reference pixel to all the pixels of the mask (280). The mask (280) may be adjusted to set a reference region to a mean value of zero by subtracting the mean value of the reference region to all the pixels of the mask (280). In an example, the plan for the build in the forming bed include a region designed to act as a reference region, where the reference region includes no consolidation, a standard formed piece to act as a reference, and/or a whole region of consolidation.

A mask (280) allows artifact removal without having to process the images (150) to create a temperature map (170). The mask (280) may be coded by the motion profile of the carriage (120). A mask (280) and/or the series of images (150) may be used to calculate a change in temperature per unit of time. This value may then be used to create a mask (280) for a different carriage (120) speed where the time difference between adjacent pixels will be changed based on the change in speed and the temperature drop between adjacent pixels will depend on the time difference multiple by the calculated value.

In an example, a mask (280) is created for each layer formed in the area (110). In another example, a mask (280) may be created every X layers, e.g., every 2 layers, 3 layers, 4 layers, 5 layers, etc. and the mask (280) applied until the next mask is made. A mask (280) may be retained based on changes in the regions being consolidated in the particulate layer. In this example, the system (100) evaluates the similarity of the last mask layer and the current layer and determines if the old mask may be applied and/or the mask should be updated. A cutoff of mean temperature difference between for the same pixel on the two layers may be used to assess the need to update the mask (280). A cutoff of maximum temperature difference may be used. A cutoff based on a percentage of pixels moving between consolidated and non-consolidated may be used. For example, the mask may update when 5% of the pixels have a different consolidated/non-consolidated state than the layer used to produce the mask. Other values, e.g., 1%, 3%, 10%, etc. may similarly be used. More complex image processing may also be used to assess the similarity of the layers. In an example, this work is performed using the build plan to reduce the processing load on the processor (160) while forming the pieces in the area (110).

In an example, the processer (160) uses the plurality of images (150) to create a cooling map, the cooling map showing a rate of change in temperature for each position of a layer on the area (110) at a constant time after exposure to the electromagnetic radiation source (130). The cooling map may report the change in temperature in degrees per second. The cooling map may be produced by comparing two images (150) for each location. The cooling map may be produced by performing a regression on a series of images, for example, three, four, five; or more images (150). The cooling map may be evaluated for anomalies where the cooling rate is unusual. In an example, the system (100) flags anomalies for user review. An anomaly may indicate a defect in a component of the system (100). For example, an anomaly may indicate that a masking ejector is not functioning properly. Anomalies may indicate areas of the layer where the material has a different density than expected. Anomalies may indicate areas of unexpected consolidation. The cooling map may be used to modify the rate of motion of the carriage (120) and the electromagnetic radiation source (130) to modify the amount of heat applied to a layer of material in the area (110).

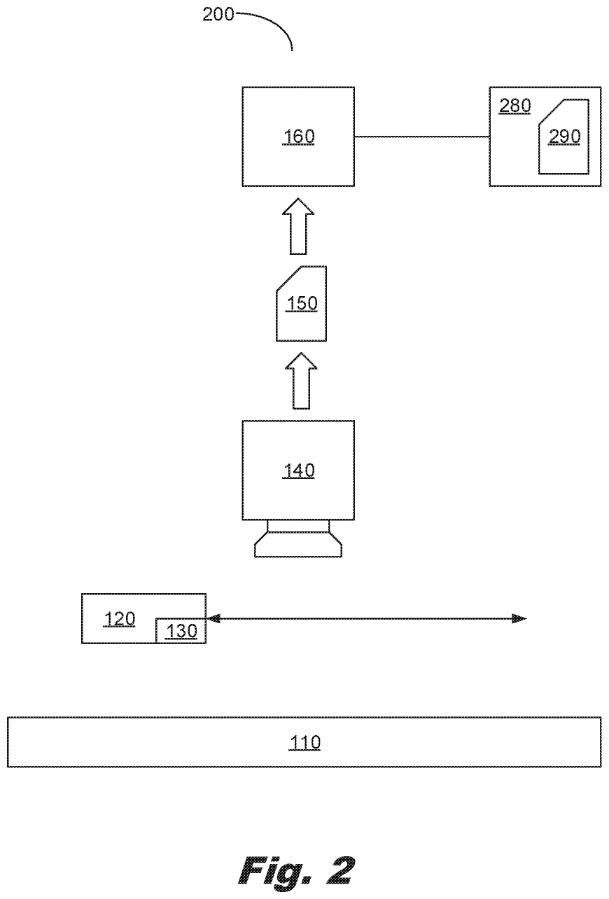

FIG. 2 shows an example of a system (200) for forming an object according to an example consistent with this specification. The system (200) includes: a carriage (120), the carriage passing back and forth above an area for forming the object (110); an electromagnetic radiation source (130) to induce heating of material in the area for forming the object (110), the electromagnetic radiation source (130) moving with the carriage (120); a thermal imagining device (140), controllable to capture an image (150) of the area for forming the object (110); a memory (280); the memory (280) comprising a mask (290) associated with a first carriage (120) speed; and a processor (160); the processor to apply the mask (290) to an image (150) of the area for forming the object (110) captured by the thermal imaging device (140).

The system (200) is a system of forming objects. The system includes a memory (280) and the memory contains a mask (290) associated with a first carriage (120) speed.

The memory (280) is able to be referenced by the processor (160). The memory (280) contains a mask (290). The memory may contain a plurality of masks (290) where each mask is associated with a different process layer, carriage (120) speed; and/or build pattern. The memory (280) may be a short term memory and/or longer term memory. The memory (280) may be a permanent storage.

The memory (280) may be remote to the other components of the system (200). For example, the memory (280) may be associated with a server providing support to operation and optimization of the system (200) based on the build plan to be executed. Remote storage has a cost in connectivity. However, remote storage can also help avoid masks (290) being used, Remote data and processing may also help offload the processor (160) being used allowing other local processes greater resources and/or limiting the specs of the processor (160) and reducing costs.

The mask (290) has an associated carriage (120) speed. The mask (280) is a pixelated collection of offsets between an image (150) of the area for forming the object (110) and a temperature map (170) where the motion artifact of the carriage (120) moving the electromagnetic radiation source (130). Because the mask (290) already includes the offsets and corrections for each of the pixel areas, a single image (150) is sufficient to create a thermal map based on the image (150) and the mask (290). This is processing resource efficient compared with calculating the temperature map (170) from scratch.

As discussed above under FIG. 1, determining how frequently to update the mask (290) to incorporate new information can be determined using a variety of different metrics. The mask (290) may be updated at fixed numbers of layers. The mask (290) may be updated based on a change, for example, in the layer pattern, of a property compared with the layer used to create the current mask (290). Similarly, monitoring the changes in the mask values can be used as a measure of uniformity through the process.

The memory (280) may have a plurality of masks (290) where different masks correspond to different carriage (120) speeds. The system (200) may include the ability to dynamically change a mask from a first carriage (120) speed to a second carriage (120) speed based on a cooling rate constant and/or formula. A cooling rate constant may be embedded in the mask (290) to facilitate this conversion. Cooling rate constants for a linear and/or non-linear cooling formula may be embedded in the mask (290) to facilitate conversion between carriage (120) speeds.

The memory (280) may include multiple masks (290) corresponding to different build plans. A given mask (290) may be optimized to reflect a given build plan, including the distribution of consolidating pieces in the build plan. The melted portions of the particle layer are warmer than the non-melted portions of the particle layer. The conduction of heat from the melted portions to the non-melted portions, the conduction of heat into the layer beneath the top layer, and radiation and/or convection of heat off the top layer into the environment all impact how the thermal distribution of the top layer changes over time. Forming an offline mask (290) adjusted for these differences allows tighter control while limiting the demands on the processor (160) while processing layers in the area (110) for forming the object.

In an example, the system (200) reviews the plurality of masks (290) in the memory (280) and elects one that best corresponds to the layer of the build plan being evaluated. This avoids the processing and customization of the mask (290) for minor adjustments and/or offsets to the build plan. In an example, there are masks (290) which ignore the conduction effects and assume radiation and convection are uniform. Such masks may be dependent on the carriage (120) speed. Such masks may be used as a first pass correction to avoid additional processing load on the system (200). In an example, masks dependent just on the carriage (120) speed are created based on a cooling rate and the carriage speed. Each pixel in such a mask (280) may be modified by the product of the time since the carriage passed over the corresponding point in the area (110) for forming the object (e.g., in seconds) and the cooling rate (in e.g., degrees C. per second).

The system (200) may also be used to monitor stability and/or non-uniformity of the electromagnetic radiation source (130). For example, an ideal electromagnetic radiation source (130) would produce a uniform intensity over the work area of the area (110) for forming the object. However, actual systems include non-uniformities, hot and/or cold spots, multiple bulbs and/or filaments with different emission properties (e.g., different ages), accumulated contaminants, etc. These may be detected by assessing the behavior of a row of pixels (a region extending in the direction X of carriage (120) travel). Further, the behavior of these rows can be monitored over time to assess when maintenance should be performed, blubs replaced, cleaning undertaken, etc.

In an example, the system detects a change in the image (150) which extends in the X direction. This change is used to notify a user. The use may then check and/or modify the electromagnetic radiation source (130). In an example, the notification to the user is a maintenance notification. In an example, the notification to the user is a part replacement notification. The system (200) may modify the mask (290) being used after detecting a change in the image (150) that extends in the X direction.

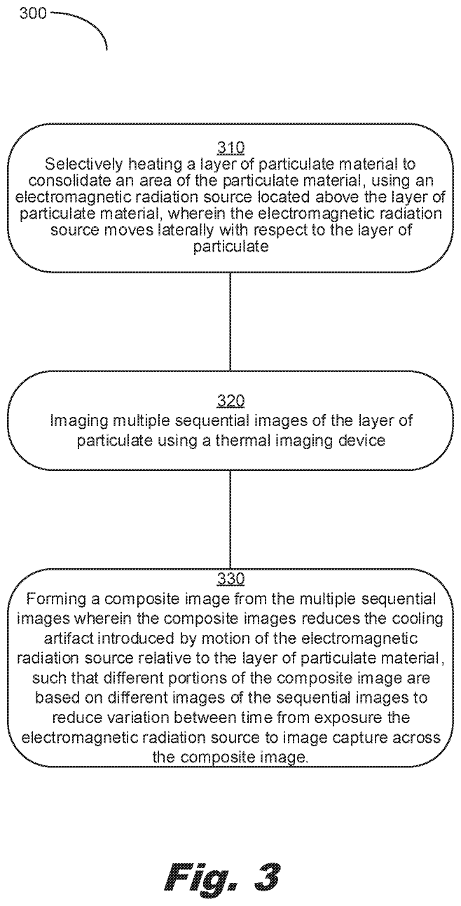

FIG. 3 shows flowchart for a method (300) of forming an object consistent with this specification. The method (300) includes: selectively heating a layer of particulate to consolidate an area of the particulate, using an electromagnetic radiation source located above the layer of particulate, wherein the electromagnetic radiation source moves laterally to the layer of particulate (310); imaging multiple sequential images of the layer of particulate using a thermal imaging device (320); and forming a composite image from the multiple sequential images wherein the composite images reduces the cooling artifact introduced by the motion of the electromagnetic radiation source relative to the bed of particulate, such that different portions of the composite image are taken from different images of the sequential images to reduce variation between time from exposure the electromagnetic radiation source to image capture across the composite image (330).

The method (300) is a method of forming an object. The method compensates for motion of an electromagnetic radiation source (130) used to heat portions of a material layer. The compensation reduces motion artifact in thermal images of the material layer in the area (110) for forming the object. The method (300) may be used with an additive manufacturing system. The method (300) may be applied using a three dimensional (3-D) printing system. The method (300) may be applied using a multi-jet fusion (MJF) system.

The method (300) includes selectively heating a layer of particulate to consolidate an area of the particulate, using an electromagnetic radiation source located above the layer of particulate, wherein the electromagnetic radiation source (130) moves laterally to the layer of particulate (310). Moving the electromagnetic radiation source (130) laterally to the layer of particulate in the area (110) allows a more uniform heating profile, especially in the lateral direction compared with using a flood and/or similar methodology that varies in both X and Y. Instead, the variability in X is a function of changes in output over time from the electromagnetic radiation source (130). In contrast, variability in Y is dependent on the spatial uniformity of output of the electromagnetic radiation source (130). In some examples, it may be possible to reduce the variability in Y by moving the carriage (120) in both X and Y. However, this increases the mechanical complexity of the carriage (120) and may increase the time to irradiate the current layer being processed in the area (110). Layer processing time is a metric used to asses forming systems. The use of a full width (in Y) electromagnetic radiation source (130) is viewed as an effective method of controlling layer processing time.

The method (300) includes selectively heating the layer of particulate. The selectivity allows fusion of the areas which will become the object(s) while not fusing the areas which will not be incorporated into the object(s). Straddling the melting and/or fusing temperature for different parts of the active layer in the area (110) implicates both magnitude and variability control of the temperature and the electromagnetic radiation source (130) providing energy to heat portions of the layer.

A variety of approaches exist for providing the selectivity in heating, including deposition of reflective materials, deposition of absorbing materials, use of multiple materials, screens, etc. Materials may be chooses with different absorptions and/or the radiation provided with a specific frequency depending on the materials on the surface.

The method (300) includes imaging multiple sequential images of the layer of particulate using a thermal imaging device (320). Having sequential images allows assessment of the cooling rate of the active layer in the cooling bed. With the temperatures at different times, linear and/or non-linear models of the cooling can be calculated and/or regressed. This information also includes information on the temperature in the neighboring pixels, although information on the layer below and direct measurement of the convection may be unavailable. Determining a cooling rate and/or model allows compensation for the time for the carriage (120) to pass from one side of the area (110) to the other. The product (or integral of the product) of the time and the cooling rate provides the temperature offset for a given pixel. The set of all such offsets forms a mask (290) which may be added or subtracted (depending on whether the values are positive or negative) to an image (150) to form a temperature map (170) which reduces the carriage (120) motion artifact.

The method (300) includes forming a composite image from the multiple sequential images (150) wherein the composite images reduces the cooling artifact introduced by the motion of the electromagnetic radiation source relative to the bed of particulate, such that different portions of the composite image are taken from different images of the sequential images to reduce variation between time from exposure the electromagnetic radiation source to image capture across the composite image (330). In an example, the value of a pixel is the value from an image closest to a fixed time after the carriage passed over the corresponding portion of the area (110). The value of a pixel may also be calculated by linearly interpolating between the two images (150) closest to this calculated offset time. This increases the uniformity and compensates for differences in the thermal imaging device (140) image capture frequency and the motion of the carriage (120). The value of a pixel may also be calculated by non-linear regression from three or more images. This increases the number of data points supporting the calculated value with will tend to reduce noise due by signal averaging. However, this approach is more computationally intensive and may place a larger load on the processor (160). Tradeoffs between processor (160) resources and increased accuracy may be especially relevant if trying to calculate the values while processing a layer. In contrast, off-line processing before and/or after and/or with a different processor may facilitate more accurate masks (290) which can be used to rapidly evaluate in-line activities without undue burden on the processor (160).

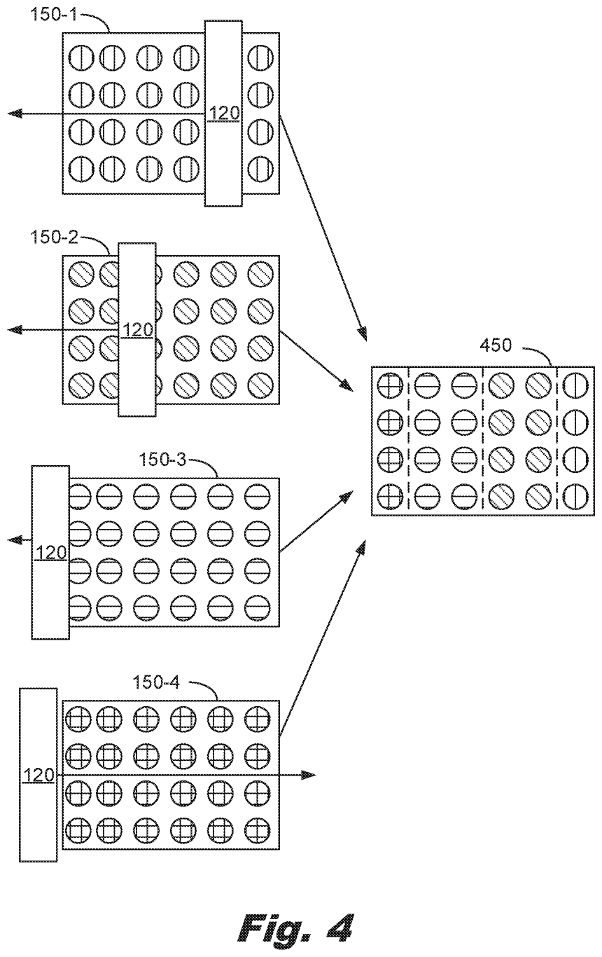

FIG. 4 shows a series of images (150-1 to 150-4) of the area (110) for forming the object and a composite image (450) formed from the series of images (150-1 to 150-4) in an example consistent with this specification. The carriage (120) passes from the first side of the area (110) to the second side before returning to the first side, as shown in image 150-4.

In each image (150) pixels are shown as patterned circles. The imagining device (140) captures an image (150) of the area (110) including portions which have recently been heated by the electromagnetic radiation source (130) associated with the carriage (120). However, not all pixels are at equal temperature. The one which have recently been exposed to the electromagnetic radiation source (130), in this example, under the carriage (120) and to the right of the carriage (120) are warmer than the areas to the left of the carriage (120) which have not yet been exposed.

As the carriage moves lateral to the forming bed, the imaging device captures sequential images (150-1 to 150-4). The images (150-1 to 150-4) are then combined to form a composite image (450). In an example, the various pixels of the composite image are broken up into regions as shown and each region is taken from the respective image (150) where the region has been most recently exposed to the electromagnetic radiation source (130) on the carriage (120). In this example, pixels that are partially obscured by the carriage (120) are excluded from the region and allowed to fall into the region corresponding to the next image (150), see, for example, the partial coverage of pixels in image 150-3 by the carriage (120).

The pixels may also be regressed and/or extrapolated using multiple images (150). For example, the right-most column of pixels provides a cooling profile for those pixels over the series of images (150-1 to 150-4). That cooling profile can be used to extrapolate the temperature of the portions of the area (110) corresponding to a given pixel at times when the pixel is obstructed, partially obstructed, and/or modified by the carriage (120). Regression also adjusts for the difference in exposure time for pixels in a single region. For example, the region of the composite image (450) taken from the second image (150-2) has two pixels width in the axis of motion of the carriage (120). The first column of pixels and the second column of pixels have different times since the carriage passed over them. Using a adjusting for this difference in time allows the first and second columns to be treated differently and may provide a tighter standard deviation on the pixels in the composite image (450). As discussed above, the cooling behavior of the layer in the area (110) may be modeled. Individual columns provide redundant measures for elapsed time which allows some averaging to reduce error. However, different heat transfer from the edges vs. the middle and from consolidated areas vs. unconsolidated areas of the layer in the area (110) may be included in this modeling, extrapolation, and/or regression. In an example, the carriage waits at the end of travel to allow a second image of the area (110) to be acquired to be used in extrapolation of pixel values. The thermal imaging device (140) may acquire images (150) during the carriage's return trip to the first side of the area (110). These images (150) may exclude regions obstructed and/or impacted by the presence of the carriage (120) in the field of view of the thermal imaging device (140).

Within the principles described by this specification, a vast number of variations and permutations exist. The examples and figures provided are representative and should not be understood to limit the scope, applicability, and/or construction of the claims in any way.

What is claimed is:

1. A system for forming an object, the system comprising:
a carriage, wherein the carriage moves above an area for forming the object and laterally with respect to the area, the carriage comprising an electromagnetic radiation source to induce heating of material in the area;
a thermal imaging device to image the area, wherein the thermal imaging device captures a plurality of sequential images; and
a processor, wherein the processor uses the plurality of sequential images to create a temperature map of the area which includes compensation for the cooling which occurs during the movement of the carriage lateral to the area.

2. The system of claim 1, wherein the processer further uses the plurality of images to create a cooling map, the cooling map showing a rate of change in temperature for each position of a layer in the area for forming the object at a constant time after exposure to the electromagnetic radiation source.

3. The system of claim 1, wherein the temperature map shows the temperature of each position of a layer on the area at a constant time after exposure to the electromagnetic radiation source.

4. The system of claim 3, wherein the temperature map includes a first region where a part is being formed and second, adjacent region without a part being formed, wherein an estimated cooling calculate for the first region is extrapolated to the second region

5. The system of claim 4, wherein the first region and second region have a same delay between exposure of the first and second regions to the electromagnetic radiation source and capture of an image of the first and second regions using the thermal imaging device.

6. The system of claim 1, wherein the thermal imaging device also captures a second plurality of images, where the second plurality of images include the carriage in the images of the second plurality of images, and the processor uses portions of the second plurality of images without the carriage to form the temperature map.

7. The system of claim 1, wherein the processor produces a mask corresponding to the difference between an image and the temperature map and the processor saves the mask in an associated memory.

8. A system for forming an object, the system comprising:
a carriage, the carriage controllable to move back and forth above an area for forming the object;
a thermal imagining device, controllable to move back and forth above the area for forming the object;
an electromagnetic radiation source to induce heating of material in the area for forming the object, the electromagnetic radiation source moving with the carriage;
a memory, the memory comprising a mask associated with a first carriage speed; and
a processor, the processor to apply the mask to an image of the area for forming the object captured by the thermal imaging device.

9. The system of claim 8, wherein the memory comprises a plurality of masks, wherein different masks in the plurality of masks correspond to different carriage speeds.

10. The system of claim 8, wherein the memory further comprises a second mask, the second mask being customized to forming a specific object or objects with a given geometry.

11. The system of claim 8, wherein the memory comprises a plurality of masks, wherein the system detects a feature in the image and selects a mask to apply to the image based on the detected feature.

12. A method of forming an object, the method comprising:
selectively heating a layer of particulate material to consolidate an area of the particulate material, using an electromagnetic radiation source located above the layer of particulate material, wherein the electromagnetic radiation source moves laterally with respect to the layer of particulate;
imaging multiple sequential images of the layer of particulate material using a thermal imaging device; and
forming a composite image from the multiple sequential images wherein the composite images reduces the cooling artifact introduced by motion of the electromagnetic radiation source relative to the layer of particulate material, such that different portions of the composite image are based on different images of the sequential images to reduce variation between time from exposure the electromagnetic radiation source to image capture across the composite image.

13. The method of claim 12, wherein the composite image further comprises portions extrapolated from multiple images.

14. The method of claim 13, wherein the extrapolation is non-linear using data points representing three or more time points taken from previously acquired images.
